(19) United States
(12) Patent Application Publication
(10) Pub. No.: US 2004/0042899 A1
(43) Pub. Date: Mar. 4, 2004

(54) All weather wind turbines

(76) Inventor: Ghazi Khan, Fremont, CA (US)

Correspondence Address: GHAZI A. KHAN, 3328 BAYLIS ST., FREMONT, CA, 94538, US

(21) Appl. No.: 10/234,408

(22) Filed: Sep. 3, 2002

(51) Int. Cl. F03D 3/06

(52) U.S. Cl. 416/51; 416/140; 416/197 A

(57) ABSTRACT

The technology of all weather wind turbine is disclosed by applying it to a savonius design wind turbine although it can be applied to all kinds of windmills based on rotational mechanism in general and specifically in the field of wind turbines. In this current embodiment the art is used to a savonius design rotor. A Savonius rotor assembly includes two blades. Each of the blades has an outer edge and an inner edge with the outer edges of the blades lying on a circle which define the diameter of the rotor. Each of the blades has a linear portion adjacent to the inner edge and a first curved portion which is substantially an arc of a circle tangent to the linear portion and tangent to the circle defining the rotor diameter. A second curved portion is substantially coincident to the circle defining the rotor diameter. In some applications multiple blades or multiple units are mounted in layers for more torque. The major modifications however from savonius type turbine are as follows:

First feature of this preferred embodiment is the free sliding movement of rotor blades/air foils cushioned by elastics/springs and balanced by counter weights. Secondly a smart self regulating system, enabling the assembly not only to survive the windy storms but also provide steadier RPMs by shutting the wind inlet gates, corresponding to the increase in RPMs caused by the gusty winds. The central shaft between the air foils can be eliminated if so desired to give free passage to the air to improve efficiency however the basic emphasis is on the principle of automatic governor mechanism rather than the rotor blade shape or angle of curve.

### I. BACKGROUND OF THE INVENTION

1. Field of the Invention

This invention pertains to a wind turbine. More particularly, this invention pertains to a wind turbine with a Savonius-design blade assembly with a self regulating mechanism to allow continuous and steady output in unpredictable windy conditions.

2. Description of the Prior Art

Savonius-type rotors is well known. Examples of such are illustrated in U.S. Pat. No. 4,784,568 and U.S. Pat. No. 4,359,311. The rotor blades are generally semi-cylindrical in shape in contrast to conventional turbines which have inner edges of the blades fixed to adjoining blades or to a central core, drum or shaft. In the design and development of Savonius rotors, the geometry of the rotor blades impacts on the power coefficient of the rotor. Accordingly, the development of blade geometry is an ongoing development for the purpose of improving the performance of Savonius rotors.

It is an object of the present invention to provide a Savonius design assembly having freely moving blades controlled by their own rotation, regulating the air intake and maintaining a safe momentum in case of windy storms causing steady currents through windy conditions.

### II. SUMMARY OF THE INVENTION

According to a preferred embodiment of the present invention, a Savonius design rotor is provided having first and second blades. Each of the blades includes an outer and an inner edge with or without a central vertical axis. The outer edge of the blades lie on a circular platform defining a diameter of the rotor and a shaft from the bottom or top of this assembly provides the rotational power. Each blade slide freely on a railing assembly in their platform and the outer blades are connected through bars or cables to the weights in opposite ends to draw the blades inward when centrifugal force is applied by the wind speed. Further the blades are kept apart by springs, tailored to withstand a critical wind pressure and gradually expand or retract with the countering weights on the opposite ends.

The wind accelerates the RPMs of rotors whereas the centrifugal force acts in sync with the rotation of the rotor blades. More spin creates more centrifugal force which in turn draws the sliding rotor blades towards the center, closing the air intake gates and reducing the spin automatically as and keeps the spin steadier though rough gusty windy conditions without damaging the assembly. The technology of this utility works with the changing winds to provide unsupervised operation continuously.

### III. BRIEF DESCRIPTION OF THE DRAWINGS

FIG. 1 is a diagrammatic view of a preferred embodiment of a two-blade Savonius-design rotor in accordance with the principals in the present invention.

FIG. 2 is an other diagrammatic view of a preferred embodiment of a two-blade Savonius-design rotor in accordance with the principals in the present invention.

FIG. 3 is a diagrammatic view of the railing system view of a preferred embodiment in accordance with the principals in the present invention.

FIG. 4 is a diagrammatic view of the embodiment with cables and weights in accordance with the principals in the present invention.

FIG. 5 is the horizontal view of the preferred embodiment in accordance with the principals in the present invention.

FIG. 6 is the side view from the upper right corner of the preferred embodiment in accordance with the principals in the present invention.

FIG. 7 is the diagrammatic view of the embodiment of two propellers in a conventional windmill by applying the principal of this new technology.

FIG. 8 is the diagrammatic view of the embodiment of two propellers in a conventional windmill in overlapping position at peak load in accordance with the principals of the present invention.

### IV. DESCRIPTION OF THE PREFERRED EMBODIMENT

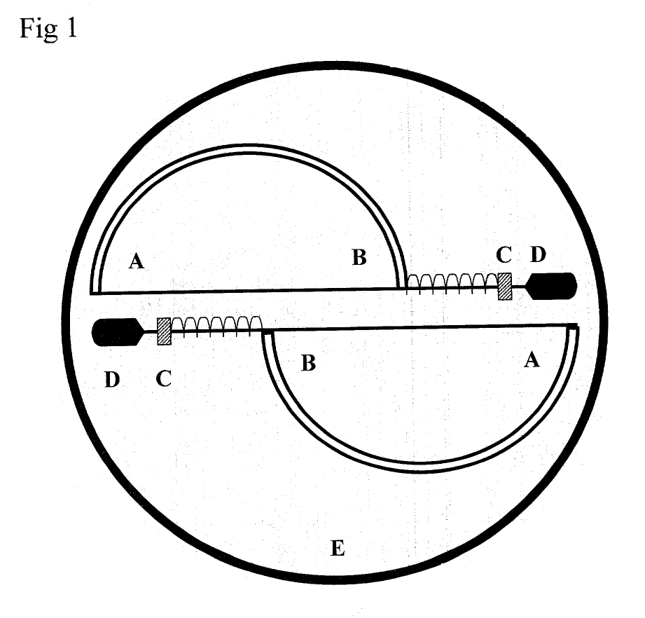

FIG. 1 shows “A & B” two sides of the rotor blades. A spring or any elastic medium is placed at the outer edge of the rotor blade “B” and the stopper “C” whereas a rod or cable is passed through this spring “BC” and connected to a weight “D”. The weights are heavier than the rotor blade on the other side from the center or if equal in weight, are placed at a more distance from the center to create more centrifugal force to draw the rotor towards the center of the platform “E”. The weights are elastic medium are calibrated with the wind speed and the size of the rotor blades so that the wind inlet blade cavity overlap the counter blade and reduce the intake of air at higher RPMs.

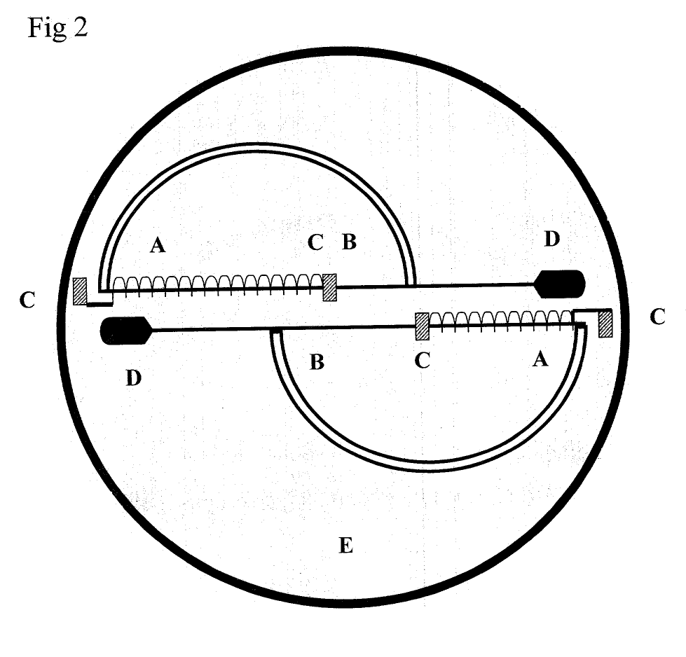

FIG. 2 has the only difference that instead of using the pressure at point “B” and causing the expanded spring or elastic medium to shrink by the centrifugal force, in FIG. 2 the spring or elastic medium is pulled to expand from point “A” by the weight “D” due to the centrifugal force effect causing the closure by overlapping the rotor blades.

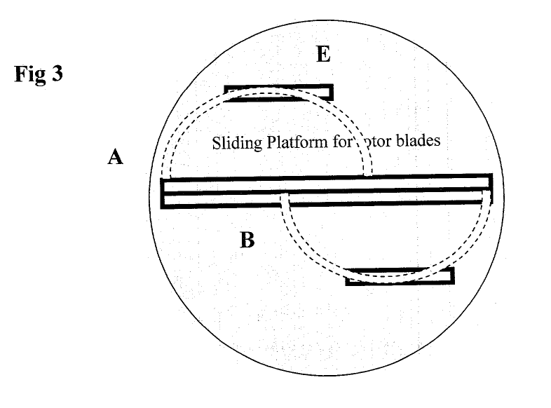

FIG. 3 is the top view of the railing over which the rotor blades move freely back and forth over the platform “E”. This sliding system is provided from the bottom and top to encase the rotor blade assembly with stoppers at the end corners.

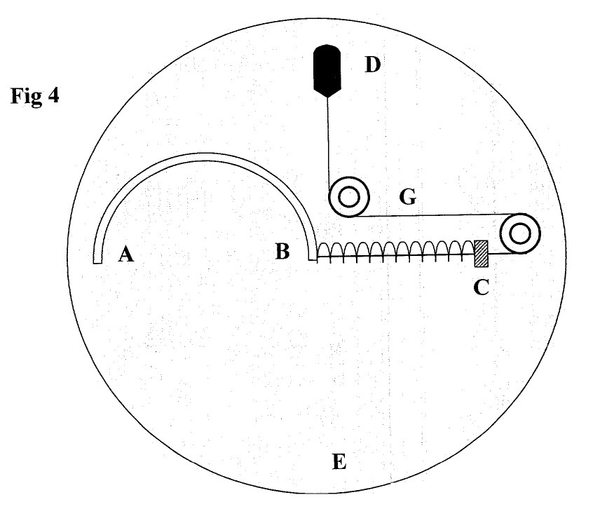

FIG. 4 is the diagrammatic view of the embodiment wherein cables are used instead of rods and pulleys “G” are used to direct the weight at a 90 degree angle and the second half in not shown.

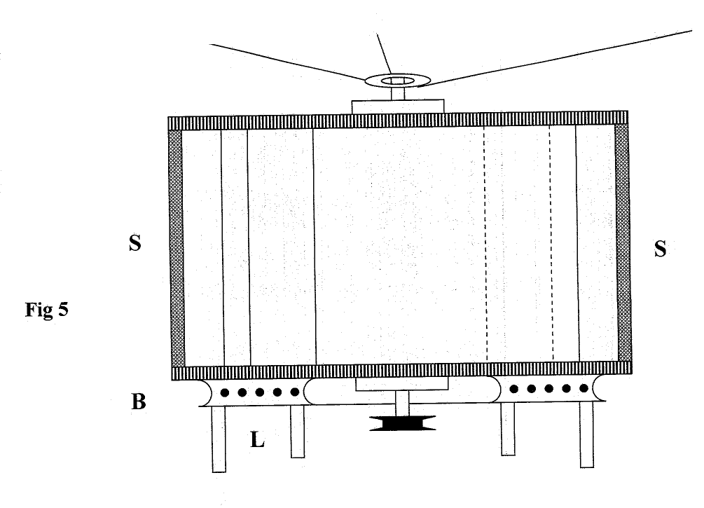

FIG. 5 is the side view of the embodiment wherein the base is shown as “B” and connecting shafts on both corners are shown as “S”. At the bottom of platform “E” is attached a ring type bearing which causes the platform assembly to rotate freely on its axis supported by its foundations shown as “L” At the top a yoke “Y” is attached with cables to the surrounding polls (Not shown).

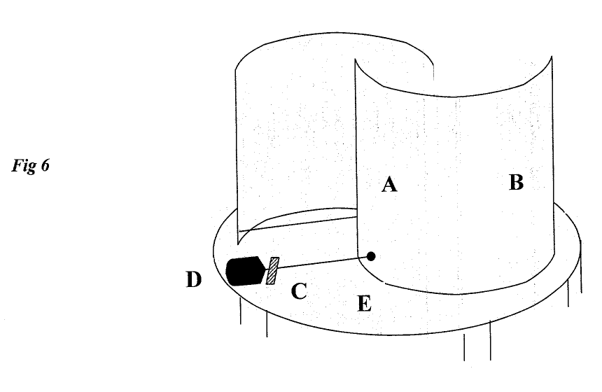

FIG. 6 is the side view from right wherein the rotor blade position is shown placed on the platform “E” and fixed stopper “C” and weight “D”.

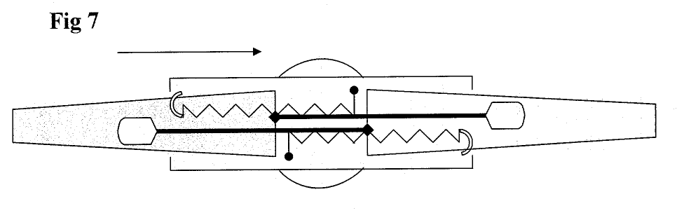

FIG. 7 is the diagrammatic view of the embodiment of two propellers in a conventional windmill by applying the principal of this new technology. Wherein the propellers circumference is reduced considerably by overlapping the propellers by the force of opposing weights to overcome the springs tension by the increased RPMs due to increased wind pressure.

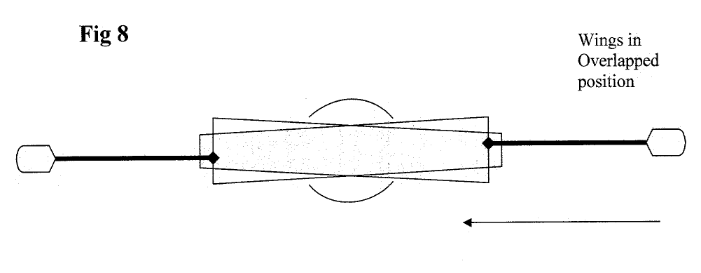

FIG. 8 is a diagrammatic view of the embodiment of two wings in a conventional windmill overlapping each other and thus reducing their circumference to withstand wind storms (sketch not to the scale but for illustration purpose only to understand the applicability of this proffered technology).

In principal the wind accelerates the RPMs of rotor blades/wings whereas the centrifugal force acts in sync with the rotation of the rotor blades. Since the weights are connected with the rotor blades in the opposite position and they exert heavier load with their spin, and draw the connected blades in an overlapping position thus reducing the air intake pressure whereas the springs tend to stretch the blades in an open position. The accelerated spin causes increase in the centrifugal force that overcomes the spring's tension and the rotor blades begin to slide in more closed position towards the center of the assembly, closing the air intake gates and reducing the spin automatically and keeps the spin steadier though rough gusty windy conditions without damaging the assembly. The technology of this utility works with the changing winds to provide unsupervised operation continuously.

What is claimed is:

1. A mechanism of free sliding movement of rotor blades/air foils cushioned by elastics/springs and balanced by counter weights enabling the assembly not only to survive the windy storms but also provide steadier RPMs by shutting the wind inlet gates, corresponding to the increase in RPMs caused by the gusty winds.

2. A cavity sail rotor assembly driven by a moving fluid or gas, said assembly comprising, an outer support assembly with or without an internal rotor shaft between the rotor blades in single or multiple blades or multistage assembly to improve efficiency however the basic emphasis is on the principle of automatic governor mechanism rather than the rotor blade shape or angle of curve.

3. An independent railing system for rotor blades to slide freely over the railing mounted on a platform E wherein the platform itself may be comprised of plastic or metal tubes rods or sheet metal in any shape, like rods, pipes or wheels and may be round, square, triangular, rectangular, pentagon, hexagon or any other shape hollow or solid. Main emphasis is on the sliding factor of rotor blades freely over its platform.

4. An assembly where the rotor blades are stretched apart to their extreme ends by springs, elastic material or any other flexible material to keep the rotor blades apart and open as far as possible in no wind conditions.

5. Counter weights are applied to close the opposite rotor blades inward by the centrifugal force caused by its rotation due to wind to narrow the air intake flow and stabilize its RPMs in a steadier motion without damaging the assembly.

6. A system where add on weights may be in solid or liquid, are connected to the weights through cables, pulleys, chains, rods, gears or any other lever system to make the blades move in towards its center and synchronize with their own spin to produce enough centrifugal force at a given wind speed, to draw the rotor blades in an overlapping position to reduce the intake of air by shutting the air intake gates in response to their own RPMs.

7. A system where the weights are positioned in such a way that they produce more centrifugal force on the opposite side of the rotor blade and positioned off from the center of the axis of moving platform than the opposite rotor blade to enable the blade to slide inward towards the center of the assembly. Weights may be positioned as part of the rotor blades inner ends.
